(19) United States
(12) Patent Application Publication
(10) Pub. No.: US 2022/0051005 A1
(43) Pub. Date: Feb. 17, 2022

(54) WALKING ESTIMATION SYSTEM, WALKING ESTIMATION METHOD, AND COMPUTER READABLE-MEDIUM

(71) Applicant: Toyota Jidosha Kabushiki Kaisha, Toyota-shi Aichi-ken (JP)

(72) Inventor: Manabu Nagai, Nagoya-shi (JP)

(21) Appl. No.: 17/396,019

(22) Filed: Aug. 6, 2021

(30) Foreign Application Priority Data
Aug. 11, 2020 (JP) 2020-135600

(51) Int. Cl. G06K 9/00; G06T 7/20; G06T 7/70; G01C 22/00

(52) U.S. Cl. CPC G06K 9/00348; G06K 9/00369; G06T 7/20; G06T 2207/30196; G01C 22/006; G06K 2209/21; G06T 7/70

(57) ABSTRACT

A walking estimation system according to the present disclosure includes: an infrastructure sensor configured to acquire an image; an analysis unit configured to analyze the image acquired by the infrastructure sensor, the image being an image containing a target pedestrian; and a step length estimation unit configured to estimate a step length of the target pedestrian based on a result of the analysis of the image containing the target pedestrian performed by the analysis unit.

### CROSS REFERENCE TO RELATED APPLICATIONS

This application is based upon and claims the benefit of priority from Japanese patent application No. 2020-135600, filed on Aug. 11, 2020, the disclosure of which is incorporated herein in its entirety by reference.

### BACKGROUND

The present disclosure relates to a walking estimation system, a walking estimation method, and a computer-readable medium.

Japanese Patent No. 5621899 discloses a technique of estimating a step length of a pedestrian based on a magnitude of acceleration detected by an acceleration sensor built-in in a terminal device worn by the pedestrian.

More specifically, Japanese Patent No. 5621899 discloses a technique of estimating a step length of a pedestrian based on a magnitude of acceleration in accordance with a model formula expressing a correlation between the acceleration and the step length.

### SUMMARY

As described above, the technique disclosed in Japanese Patent No. 5621899 estimates the step length of a pedestrian based only on the magnitude of acceleration detected by an acceleration sensor.

However, it is considered that the magnitude of acceleration differs even among pedestrians with the same the step length as a result of differences between the situations of pedestrians. It is considered that the magnitude of acceleration differs among pedestrians as a result of, for example, differences between the ways each of the pedestrians walk, each of the physiques of the pedestrians, each of the positions of the acceleration sensors (for instance, whether each of the pedestrians is holding the acceleration sensor in his/her hand or whether each of the pedestrians has the acceleration sensor in his/her pocket).

Therefore, regarding the technique disclosed in Japanese Patent 5621899, there is a problem that the accuracy of the estimation of the step length degrades when the step length of a pedestrian is estimated based only on the magnitude of acceleration.

The present disclosure has been made in view of the problem mentioned above. An object of the present disclosure is to provide a walking estimation system, a walking estimation method, and a computer readable medium that can suppress degradation in the accuracy of the estimation of the step length of a pedestrian.

A walking estimation system according to an exemplary aspect includes:

an infrastructure sensor configured to acquire an image;

an analysis unit configured to analyze the image acquired by the infrastructure sensor, the image being an image containing a target pedestrian; and

a step length estimation unit configured to estimate a step length of the target pedestrian based on a result of the analysis of the image containing the target pedestrian performed by the analysis unit.

A walking estimation method according to another exemplary aspect includes:

acquiring an image by an infrastructure sensor;

analyzing the image acquired by the infrastructure sensor, the image being an image containing a target pedestrian; and

estimating a step length of the target pedestrian based on a result of the analysis of the image containing the target pedestrian.

A non-transitory computer readable-medium according to another exemplary aspect stores a program for causing a computer to execute the processes of:

analyzing an image acquired by an infrastructure sensor, the image being an image containing a target pedestrian; and

estimating a step length of the target pedestrian based on a result of the analysis of the image containing the target pedestrian.

According to the aspects of the present disclosure described above, it is possible to provide a walking estimation system, a walking estimation method, and a computer readable medium that can suppress degradation in the accuracy of the estimation of the step length of a pedestrian.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing an example of a configuration of a walking estimation system according to a first embodiment;

FIG. 2 is a diagram showing an example of installation of the camera shown in FIG. 1;

FIG. 3 is a block diagram showing an example of a configuration of a step length estimation unit shown in FIG. 1;

FIG. 4 is a flowchart showing an example of a flow of an estimation method of estimating a step length of a target pedestrian in the step length estimation unit shown in FIG. 3;

FIG. 5 is a flowchart showing an example of an overall flow of processing performed by the walking estimation system shown in FIG. 1;

FIG. 6 is a block diagram showing an example of a configuration of a walking estimation system according to a second embodiment;

FIG. 7 is a flowchart showing an example of an overall flow of processing performed by the walking estimation system shown in FIG. 6;

FIG. 8 is a block diagram showing an example of a configuration of a walking estimation system according to a third embodiment;

FIG. 9 is a flowchart showing an example of an overall flow of processing performed by the walking estimation system shown in FIG. 8;

FIG. 10 is a block diagram showing an example of a configuration of a walking estimation system according to a fourth embodiment;

FIG. 11 is an example of a correspondence table held by the distribution unit shown in FIG. 10;

FIG. 12 is a flowchart showing an example of an overall flow of processing performed by the walking estimation system shown in FIG. 10;

FIG. 13 is a block diagram showing an example of a configuration of a walking estimation system schematically illustrating the embodiments; and

FIG. 14 is a flowchart showing an example of an overall flow of processing performed by the walking estimation system shown in FIG. 13.

### DESCRIPTION OF EMBODIMENTS

Hereinafter, embodiments of the present disclosure will be described with reference to the drawings. In the drawings, the identical reference symbols denote identical structural elements and the redundant explanation thereof is omitted where appropriate.

### First Embodiment

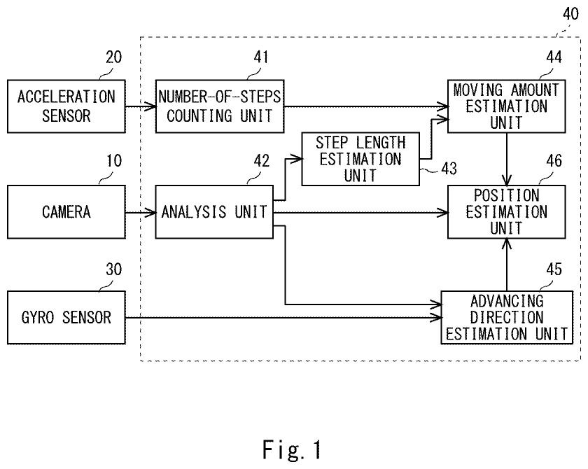

First, an example of a configuration of a walking estimation system according to a first embodiment will be described with reference to FIG. 1.

As shown in FIG. 1, the walking estimation system according to the first embodiment includes a camera 10, an acceleration sensor 20, a gyro sensor 30, and a walking estimation apparatus 40. Further, the walking estimation apparatus 40 includes a number-of-steps counting unit 41, an analysis unit 42, a step length estimation unit 43, a moving amount estimation unit 44, an advancing direction estimation unit 45, and a position estimation unit 46.

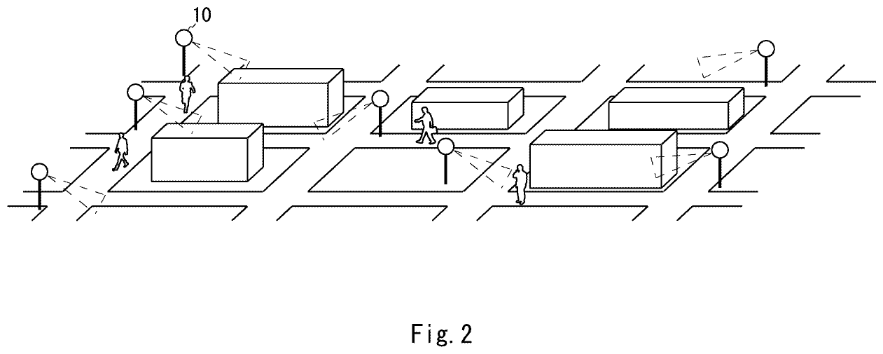

The camera 10 is an example of an infrastructure sensor that performs photographing and acquires a picture (hereinafter referred to as a camera image). In the first embodiment, the camera 10 is used to detect the position of a target pedestrian. The camera 10 is installed, for instance, in a town as shown in FIG. 2. Note that the camera 10 may be installed at any place in a town such as on a utility pole, in a building, and the like. Note that in FIG. 1, a plurality of cameras 10 are shown, however, the number of cameras 10 installed may be at least one.

The acceleration sensor 20 and the gyro sensor 30 are built-in in a terminal carried by the target pedestrian. The terminal carried by the target pedestrian may be a portable terminal or a wearable terminal, the portable terminal being a terminal that can be carried by the target pedestrian such as a smartphone, a mobile phone, a tablet terminal, and a portable game device, and the wearable terminal being a terminal that can be worn by the target pedestrian on his/her wrist, arm, head, or the like.

The acceleration sensor 20 is a sensor that detects acceleration in orthogonal three axes. The gyro sensor 30 is a sensor for detecting an angular velocity in orthogonal three axes. Note that in FIG. 1, the acceleration sensor 20 and the gyro sensor 30 are shown as mutually independent sensors, however, the acceleration sensor 20 and the gyro sensor 30 may be configured as an integral sensor.

Note that the camera image acquired by the camera 10 is radio-transmitted to the walking estimation apparatus 40 by the camera 10 or any other communication apparatus. Similarly, information on the acceleration acquired by the acceleration sensor 30 is radio-transmitted to the walking estimation apparatus 40 by the acceleration sensor 20 or any other communication apparatus, and information on the angular velocity acquired by the gyro sensor 30 is radio-transmitted to the walking estimation apparatus 40 by the gyro sensor 30 or any other communication apparatus. Further, the communication system employed in performing the radio transmission is not particularly limited and may be any known communication system.

The number-of-steps counting unit 41 counts the number of steps of the target pedestrian based on the acceleration detected by the acceleration sensor 20. Note that a method of detecting the number of steps from the acceleration in the number-of-steps counting unit 41 is not particularly limited, and any known method like that disclosed in Japanese Patent 5621899 may be used.

The analysis unit 42 analyzes the camera image acquired by the camera 10, which is a camera image containing the target pedestrian. To be more specific, the analysis unit 42 detects the position of the target pedestrian by analyzing the camera image containing the target pedestrian. Note that a method of detecting the position of the target pedestrian from the camera image in the analysis unit 42 is not particularly limited, and any known image recognition technique may be used.

The step length estimation unit 43 estimates the step length of the target pedestrian based on the result of analysis of the camera image containing the target pedestrian performed by the analysis unit 42. To be more specific, the step length estimation unit 43 estimates the step length of the target pedestrian based on the position of the target pedestrian which is detected from the analysis of the camera image performed by the analysis unit 42. Note that a concrete method of estimating a step length of a target pedestrian in the step length estimation unit 43 will be described later.

Note that the analysis unit 42 and the step length estimation unit 43 start performing the operations described above after the target pedestrian enters within the angle of view of the camera 10 and perform estimation and update of the step length of the target pedestrian. The step length of the target pedestrian before the target pedestrian enters the angle of view of the camera 10, may be, for instance, a fixed step length that is preset.

The moving amount estimation unit 44 estimates the moving amount of the target pedestrian based on the number of steps of the target pedestrian counted up by the number-of-steps counting unit 41 and the step length of the target pedestrian estimated by the step length estimation unit 43. To be more specific, the moving amount estimation unit 44 estimates the product of the number of steps of the target pedestrian and the step length of the target pedestrian as the moving amount of the target pedestrian.

The advancing direction estimation unit 45 estimates the advancing direction of the target pedestrian based on the angular velocity detected by the gyro sensor 30. Note that a method of estimating the advancing direction of the pedestrian from the angular velocity in the advancing direction estimation unit 45 is not particularly limited, and any known method such as the one disclosed in Japanese Patent No. 5621899 may be used.

Note that when the target pedestrian is within the angle of view of the camera 10, the analysis unit 42 can detect the position of the target pedestrian from the camera image. Therefore, in this case, the advancing direction estimation unit 45 may use the information on the position of the target pedestrian detected by the analysis unit 42 in estimating the advancing direction of the target pedestrian. For instance, the advancing direction estimation unit 45 may correct the estimated advancing direction of the target pedestrian based on the position of the target pedestrian detected by the analysis unit 42.

The position estimation unit 46 estimates the position of the target pedestrian based on the moving amount of the target pedestrian estimated by the moving amount estimation unit 44 and the advancing direction of the target pedestrian estimated by the advancing direction estimation unit 45. For instance, the position estimation unit 46 holds map data, and by comparing the moving amount and the advancing direction of the target pedestrian with the map data, the position estimation unit 46 can estimate the position of the target pedestrian on the map.

Note that when the target pedestrian is within the angle of view of the camera 10, the analysis unit 42 can detect the position of the target pedestrian from the camera image. Therefore, in this case, the position estimation unit 46 may use the information on the position of the target pedestrian detected by the analysis unit 42 in estimating the position of the target pedestrian. For instance, the position estimation unit 46 may correct the estimated position of the target pedestrian based on the position of the target pedestrian detected by the analysis unit 42. Alternatively, the position estimation unit 46 may estimate the position of the target pedestrian to be the position detected by the analysis unit 42.

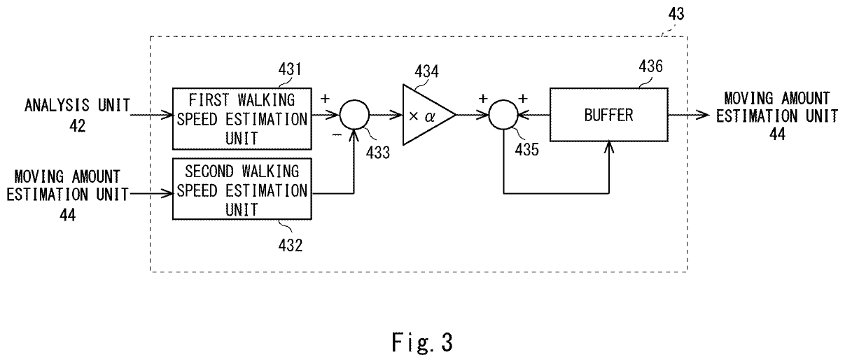

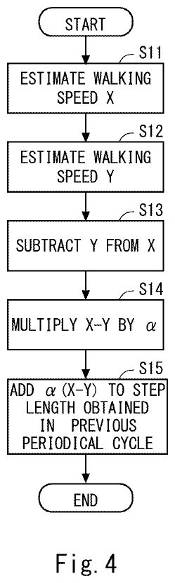

Next, the configuration of the step length estimation unit 43 and the concrete method of estimating the step length of the target pedestrian performed by the step length estimation unit 43 will be described with reference to FIGS. 3 and 4. Here, the step length estimation unit 43 shall periodically estimate the step length of the target pedestrian (hereinbelow referred to as a periodical cycle). Further, here, the step length estimation unit 43 shall estimate the step length of the target pedestrian based on the position of the target pedestrian detected by the analysis unit 42 and the moving amount of the target pedestrian estimated by the moving amount estimation unit 44.

First, an example of a configuration of the step length estimation unit 43 shown in FIG. 1 will be described with reference to FIG. 3. As shown in FIG. 3, the step length estimation unit 43 includes a first walking speed estimation unit 431, a second walking speed estimation unit 432, a subtracter 433, a multiplier 434, an adder 435, and a buffer 436.

The first walking speed estimation unit 431 estimates the walking speed of the target pedestrian based on the position of the target pedestrian detected by the analysis unit 42. Hereinbelow, the walking speed estimated by the first walking speed estimation unit 431 is referred to as a walking speed X.

The second walking speed estimation unit 432 estimates the walking speed of the target pedestrian based on the moving amount of the target pedestrian estimated by the moving amount estimation unit 44. Hereinbelow, the walking speed estimated by the second walking speed estimation unit 432 is referred to as a walking speed Y. Note that the moving amount of the target pedestrian at this time is the moving amount estimated by the moving amount estimation unit 44 based on the step length of the target pedestrian estimated by the step length estimation unit 43 in the previous periodical cycle.

The subtracter 433 calculates (X−Y) by subtracting the walking speed Y estimated by the second walking speed estimation unit 432 from the walking speed X estimated by the first walking speed estimation unit 431. The multiplier 434 calculates α(X−Y) by multiplying (X−Y) calculated by the subtracter 433 by a prescribed coefficient α.

At this time, the information on the step length of the target pedestrian estimated by the step length estimation unit 43 in the previous periodical cycle is stored in the buffer 436. The adder 435 adds α(X−Y) calculated by the multiplier 434 and the step length of the target pedestrian that is estimated in the previous periodical cycle and stored in the buffer 436.

The buffer 436 regards the result of the addition performed by the adder 435 as the step length of the target pedestrian estimated by the step length estimation unit 43 in the current periodical cycle. The buffer 436 then stores therein as well as outputs to the moving amount estimation unit 44 the information on the step length of the target pedestrian that has been newly estimated.

Next, an example of a flow of an estimation method of estimating a step length of a target pedestrian in the step length estimation unit 43 shown in FIG. 3 will be descried with reference to FIG. 4. Note that the flow shown in FIG. 4 is performed on a periodic basis.

As shown in FIG. 4, the first walking speed estimation unit 431 estimates the walking speed X of the target pedestrian based on the position of the target pedestrian detected by the analysis unit 42 (Step S11). Next, the second walking speed estimation unit 432 estimates the walking speed Y of the target pedestrian based on the moving amount of the target pedestrian estimated by the moving amount estimation unit 44 (Step S12).

Next, the subtracter 433 calculates (X−Y) by subtracting the walking speed Y estimated by the second walking speed estimation unit 432 from the walking speed X estimated by the first walking speed estimation unit 431 (Step S13). Next, the multiplier 434 calculates α(X−Y) by multiplying (X−Y) calculated by the subtracter 433 by a prescribed coefficient a (Step S14).

Then, the adder 435 adds α(X−Y) calculated by the multiplier 434 and the step length of the target pedestrian that is estimated in the previous periodical cycle and stored in the buffer 436 (Step S15). This result of the addition is stored in the buffer 436 as well as output to the moving amount estimation unit 44 as the information on the step length of the target pedestrian newly estimated by the step length estimation unit 43 in the current periodical cycle.

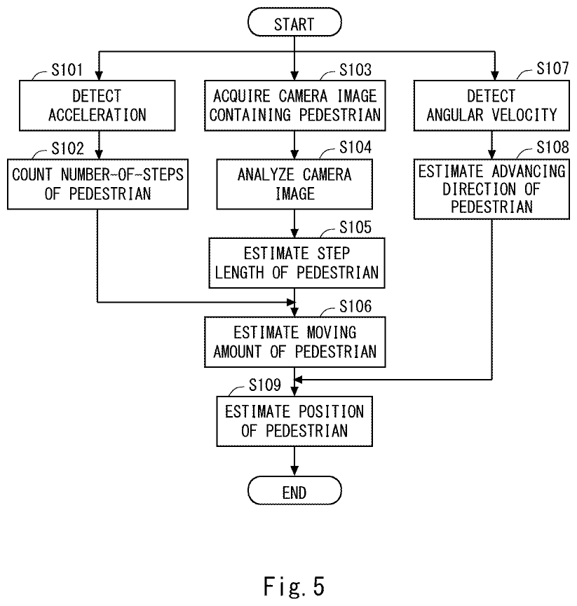

Next, an example of an overall flow of processing performed by the walking estimation system according to the first embodiment shown in FIG. 1 will be described with reference to FIG. 5. Here, it is assumed that the target pedestrian is within the angle of view of the camera 10.

As shown in FIG. 5, the acceleration sensor 20 detects the acceleration generated by the target pedestrian (Step S101). Next, the number-of-steps counting unit 41 counts up the number of steps of the target pedestrian based on the acceleration detected by the acceleration sensor 20 (Step S102).

Further, the camera 10 acquires the camera image containing the target pedestrian (Step S103). Next, the analysis unit 42 analyzes the camera image containing the target pedestrian which is a camera image acquired by the camera 10 (Step S104). Next, the step length estimation unit 43 estimates the step length of the target pedestrian based on the result of the analysis of the camera image containing the target pedestrian performed by the analysis unit 42 (Step S105). To be more specific, the analysis unit 42 detects the position of the target pedestrian by analyzing the camera image containing the target pedestrian, and the step length estimation unit 43 estimates the step length of the target pedestrian based on the position of the target pedestrian which is detected from the analysis of the camera image performed by the analysis unit 42. Next, the moving amount estimation unit 44 estimates the moving amount of the target pedestrian based on the number of steps of the target pedestrian counted by the number-of-steps counting unit 41 and the step length of the target pedestrian estimated by the step length estimation unit 43 (Step S106).

Further, the gyro sensor 30 detects the angular velocity generated by the target pedestrian (Step S107). Next, the advancing direction estimation unit 45 estimates the advancing direction of the target pedestrian based on the angular velocity detected by the gyro sensor 30 (Step S108). At this time, the advancing direction estimation unit 45 may use the information on the position of the target pedestrian detected by the analysis unit 42 in estimating the advancing direction of the target pedestrian.

Next, the position estimation unit 46 estimates the position of the target pedestrian based on the moving amount of the target pedestrian estimated by the moving amount estimation unit 44 and the advancing direction of the target pedestrian estimated by the advancing direction estimation unit 45 (Step S109). At this time, the position estimation unit 46 may use the information on the position of the target pedestrian detected by the analysis unit 42 in estimating the position of the target pedestrian.

As described above, in the walking estimation system according to the first embodiment, the analysis unit 42 analyzes the camera image acquired by the camera 10, which is a camera image containing the target pedestrian. Then, the step length estimation unit 43 estimates the step length of the target pedestrian based on the result of the analysis of the camera image performed by the analysis unit 42.

By this configuration, it is possible to suppress degradation in the accuracy of the estimation of the step length of the target pedestrian due to the difference in the situation of the target pedestrian such as the way the target pedestrian walks.

### Second Embodiment

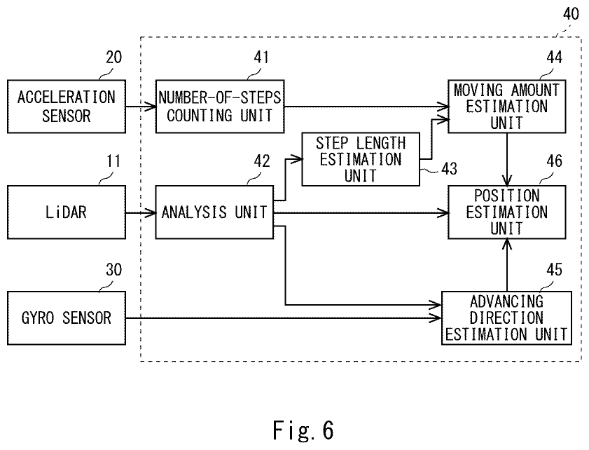

Next, an example of a configuration of a walking estimation system according to a second embodiment will be described with reference to FIG. 6.

As shown in FIG. 6, the walking estimation system according to the second embodiment differs from the walking estimation system according to the above-described first embodiment shown in FIG. 1 in that a LiDAR (Light Detection and Ranging) 11 is provided in place of the camera 10 as an infrastructure sensor.

The LiDAR 11 performs sensing of a target object by irradiating a laser light on the target object and can detect the position of the target object from the sensing result of the LiDAR 11. In the second embodiment, the LiDAR 11 is used in detecting the position of the target pedestrian. Like the camera 10, the LiDAR 11 may be installed at any place in a town. Further, like the camera 10, the number of LiDAR 11 installed may be at least one.

The LiDAR 11 performs sensing of a target object present in the vicinity of the LiDAR 11 and imaging of the result of the sensing to thereby acquire a sensing image.

Note that the sensing image acquired by the LiDAR 11 is radio-transmitted to the walking estimation apparatus 40 by the LiDAR 11 or any other communication apparatus. Further, the communication system employed in performing the radio transmission is not particularly limited and may be any known communication system.

The analysis unit 42 analyzes the sensing image acquired by the LiDAR 11, which is a sensing image containing the target pedestrian. To be more specific, the analysis unit 42 detects the position of the target pedestrian by analyzing the sensing image of the target pedestrian. Note that a method of detecting the position of the target pedestrian from the sensing image in the analysis unit 42 is not particularly limited, and any known method may be used.

The step length estimation unit 43 estimates the step length of the target pedestrian based on the result of analysis of the sensing image containing the target pedestrian performed by the analysis unit 42. To be more specific, the step length estimation unit 43 estimates the step length of the target pedestrian based on the position of the target pedestrian which is detected from the analysis of the sensing image performed by the analysis unit 42. For instance, the step length estimation unit 43 may be configured as shown in FIG. 3 and may estimate the step length of the target pedestrian by the method shown in FIG. 4.

Note that the analysis unit 42 and the step length estimation unit 43 start performing the operations described above after the target pedestrian enters within the range that can be sensed by the LiDAR 11, to thereby perform estimation and update of the step length of the target pedestrian. The step length of the target pedestrian before the target pedestrian enters within the range that can be sensed by the LiDAR 11, may be, for instance, a fixed step length that is preset.

Further, the LiDAR 11 does not need to perform imaging of the sensing result of the target pedestrian. In this case, the analysis unit 42 may detect the position of the target pedestrian by analyzing the sensing result of the target pedestrian that is sensed by the LiDAR 11. Further, the step length estimation unit 43 may estimate the step length of the target pedestrian based on the position of the target pedestrian detected from the analysis of the sensing result performed by the analysis unit 42.

Except for the aforementioned configuration, the walking estimation system according to the second embodiment is the same as that according to the above-described first embodiment.

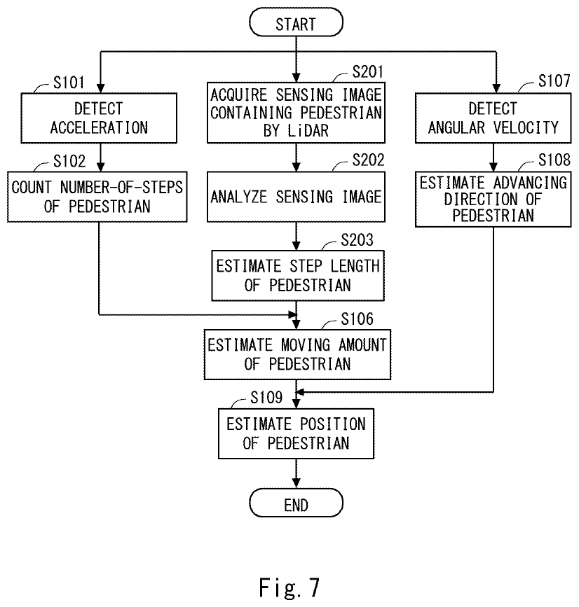

Next, an example of an overall flow of processing performed by the walking estimation system according to the second embodiment shown in FIG. 6 will be described with reference to FIG. 7. Here, it is assumed that the target pedestrian is within the range that can be sensed by the LiDAR 11.

The overall processing of the walking estimation system according to the second embodiment shown in FIG. 7 differs from that of the walking estimation system according to the above-described first embodiment shown in FIG. 5 in that Steps S201 to S203 are performed in place of Steps S103 to S105. Hereinbelow, only the steps that are different from those shown in FIG. 5, that is, Steps S201 to S203, will be described.

The LiDAR 11 performs sensing of the target pedestrian and imaging of the result of the sensing to thereby acquire a sensing image (Step S201). Next, the analysis unit 42 analyzes the sensing image of the target pedestrian acquired by the LiDAR 11 (Step S202). Next, the step length estimation unit 43 estimates the step length of the target pedestrian based on the result of analysis of the sensing image containing the target pedestrian performed by the analysis unit 42 (Step S203). To be more specific, the analysis unit 42 detects the position of the target pedestrian by analyzing the sensing image of the target pedestrian, and the step length estimation unit 43 estimates the step length of the target pedestrian based on the position of the target pedestrian detected from the analysis of the sensing image performed by the analysis unit 42.

As described above, in the walking estimation system according to the second embodiment, the analysis unit 42 analyzes the sensing image acquired by the LiDAR 11, which is a sensing image containing the target pedestrian. Then, the step length estimation unit 43 estimates the step length of the target pedestrian based on the result of the analysis of the sensing image performed by the analysis unit 42.

By this configuration, it is possible to suppress degradation in the accuracy of the estimation of the step length of the target pedestrian, the difference in the status of the pedestrian such as the way the target pedestrian walks and the like degrading being the cause of the degradation.

### Third Embodiment

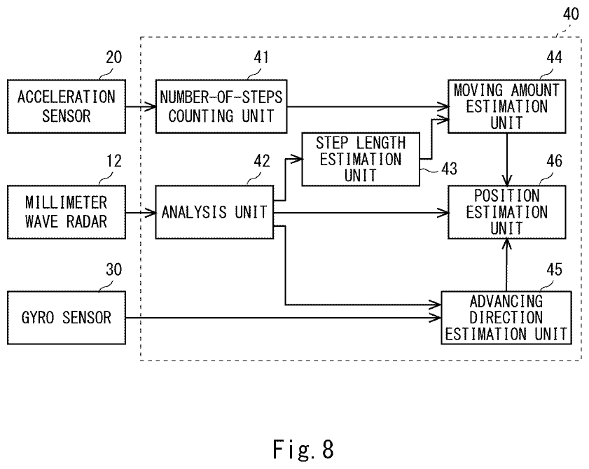

Next, an example of a configuration of a walking estimation system according to a third embodiment will be described with reference to FIG. 8.

The walking estimation system according to the third embodiment as shown in FIG. 8 differs from the walking estimation system according to the above-described first embodiment as shown in FIG. 1 in that a millimeter wave radar 12 is provided in place of the camera 10 as an infrastructure sensor.

The millimeter wave radar 12 performs sensing of a target object by irradiating a millimeter wave radar on the target object and can detect the position and the speed of the target object from the sensing result of the millimeter wave radar 12. In the third embodiment, the millimeter wave radar 12 is used for detecting the walking speed of the target pedestrian. Like the camera 10, millimeter wave radar 12 may be installed at any place in a town. Further, like the camera 10, the number of the millimeter wave radar 12 installed may be at least one.

The millimeter wave radar 12 performs sensing of a target object present in the vicinity of the millimeter wave radar 12 and imaging of the result of the sensing to thereby acquire a sensing image.

Note that the sensing image acquired by the millimeter wave radar 12 is radio-transmitted to the walking estimation apparatus 40 by the millimeter wave radar 12 or any other communication apparatus. Further, the communication system employed in performing the radio transmission is not particularly limited and may be any known communication system.

The analysis unit 42 analyzes the sensing image acquired by the millimeter wave radar 12, which is a sensing image containing the target pedestrian. To be more specific, the analysis unit 42 detects the walking speed of the target pedestrian by analyzing the sensing image of the target pedestrian. Note that a method of detecting the walking speed of the target pedestrian from the sensing image in the analysis unit 42 is not particularly limited, and any known method may be used.

The step length estimation unit 43 estimates the step length of the target pedestrian based on the result of analysis of the sensing image containing the target pedestrian performed by the analysis unit 42. To be more specific, the step length estimation unit 43 estimates the step length of the target pedestrian based on the walking speed of the target pedestrian which is detected from the analysis of the sensing image performed by the analysis unit 42. For instance, the step length estimation unit 43 may be configured such that the first walking speed estimation unit 431 is eliminated from the configuration shown in FIG. 3 and the walking speed of the target pedestrian detected by the analysis unit 42 is input as the walking speed X. Note that the step length estimation unit 43 may estimate the step length of the target pedestrian by performing Step S12 and the subsequent steps shown in FIG. 4.

Note that the analysis unit 42 and the step length estimation unit 43 start performing the operations described above after the target pedestrian enters within the range that can be sensed by the millimeter wave radar 12, to thereby perform estimation and update of the step length of the target pedestrian. The step length of the target pedestrian before the target pedestrian enters within the range that can be sensed by the millimeter wave radar 12, may be, for instance, a fixed step length that is preset.

Further, the millimeter wave radar 12 does not need to perform imaging of the sensing result of the target pedestrian. In this case, the analysis unit 42 may detect the walking speed of the target pedestrian by analyzing the result of the sensing of the target pedestrian performed by the millimeter wave radar 12. Further, the step length estimation unit 43 may estimate the step length of the target pedestrian based on the walking speed of the target pedestrian detected from the analysis of the sensing result performed by the analysis unit 42.

Except for the aforementioned configuration, the walking estimation system according to the third embodiment is the same as that according to the above-described first embodiment.

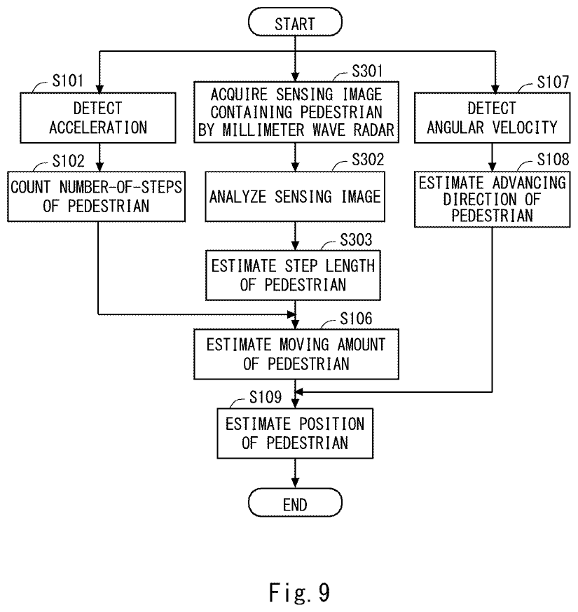

Next, an example of an overall flow of processing performed by the walking estimation system according to the third embodiment shown in FIG. 8 will be described with reference to FIG. 9. Here, it is assumed that the target pedestrian is within the range that can be sensed by the millimeter wave radar 12.

The overall processing of the walking estimation system according to the third embodiment as shown in FIG. 9 differs from that of the walking estimation system according to the above-described first embodiment shown in FIG. 5 in that

Steps S301 to S303 are performed in place of Steps S103 to S105. Hereinbelow, only the steps that are different from those shown in FIG. 5, that is, Steps S301 to S303, will be described.

The millimeter wave radar 12 performs sensing of the target pedestrian and imaging of the result of the sensing to thereby acquire a sensing image (Step S301).

Next, the analysis unit 42 analyzes the sensing image of the target pedestrian acquired by the millimeter wave radar 12 (Step S302). Next, the step length estimation unit 43 estimates the step length of the target pedestrian based on the result of analysis of the sensing image containing the target pedestrian performed by the analysis unit 42 (Step S303). To be more specific, the analysis unit 42 detects the walking speed of the target pedestrian by analyzing the sensing image of the target pedestrian, and the step length estimation unit 43 estimates the step length of the target pedestrian based on the walking speed of the target pedestrian detected from the analysis of the sensing image performed by the analysis unit 42.

As described above, in the walking estimation system according to the third embodiment, the analysis unit 42 analyzes the sensing image acquired by the millimeter wave radar 12, which is a sensing image containing the target pedestrian. Then, the step length estimation unit 43 estimates the step length of the target pedestrian based on the result of the analysis of the sensing image performed by the analysis unit 42. By this configuration, it is possible to suppress degradation in the accuracy of the estimation of the step length of the target pedestrian due to the difference in the situation of the target pedestrian such as the way the target pedestrian walks.

### Fourth Embodiment

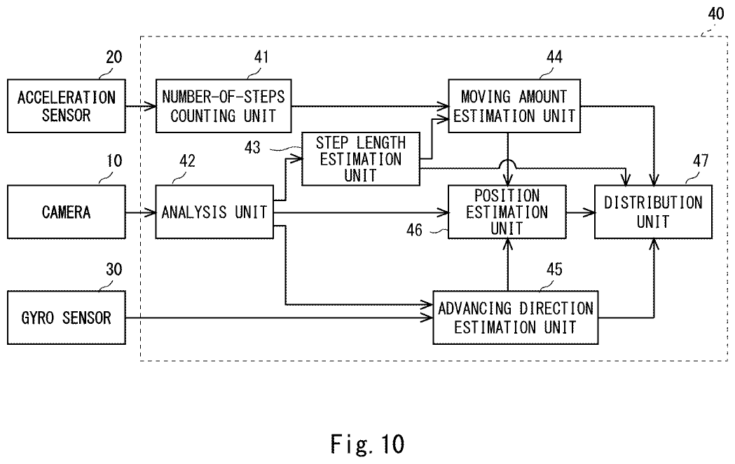

Next, an example of a configuration of a walking estimation system according to a fourth embodiment will be described with reference to FIG. 10.

The walking estimation system according to the fourth embodiment as shown in FIG. 10 differs from the walking estimation system according to the above-described first embodiment in that a distribution unit 47 is added inside the walking estimation apparatus 40.

The distribution unit 47 distributes at least one of the following information to a specific terminal associated with the identification information such as the ID (Identification) of the target pedestrian:

information on the step length of target pedestrian estimated by the step length estimation unit 43;
information on the moving amount of the target pedestrian estimated by the moving amount estimation unit 44;
information on the advancing direction of the target pedestrian estimated by the advancing direction estimation unit 45; and
information on the position of the target pedestrian estimated by the position estimation unit 46.

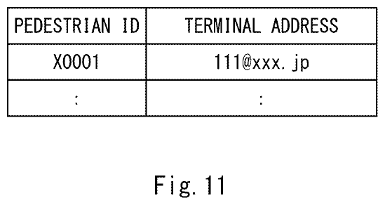

The distribution unit 47 holds a correspondence table in which the ID of the target pedestrian and information identifying the specific terminal (the email address of the specific terminal in the example shown in FIG. 11) are associated as shown in FIG. 11, and specifies the specific terminal associated with the ID of the target pedestrian by referring to the correspondence table.

When there is only one target pedestrian, only one target pedestrian is entered in the correspondence table. Therefore, the distribution unit 47 is able to uniquely specify the specific terminal associated with the ID of the target pedestrian.

On the other hand, when there are more than one target pedestrian, a plurality of target pedestrians are entered in the correspondence table. Therefore, the distribution unit 47 needs to specify the ID of the target pedestrian whose step length or the like has been estimated in order to distribute the above-described information to the target pedestrian.

Therefore, it is conceivable that the distribution unit 47 estimates the ID of the target pedestrian whose step length or the like has been estimated in the following manner.

For instance, at least one communication apparatus for detection is disposed in a photographable region of the camera 10, which is a region that can be photographed by the camera 10, the apparatus being able to detect a terminal moving within the photographable region and to communicate with the detected terminal. When the step length estimation unit 43 estimates the step length of the target pedestrian using the camera image acquired by the camera 10, the communication apparatus for detection disposed in the photographable region of the camera 10 attempts to detect the terminal. The communication apparatus for detection acquires the ID of the person who is carrying the detected terminal by communicating with the detected terminal. The distribution unit 47 regards the terminal detected by the communication apparatus for detection as the terminal carried by the target pedestrian, and specifies the ID acquired by the communication apparatus for detection as the ID of the target pedestrian. The method of specifying the ID of the target pedestrian is not limited to the above, and any other known method may be used.

Note that the specific terminal associated with the ID of the target pedestrian may be the terminal carried by the target pedestrian or may be a terminal installed at home or the like of the target pedestrian.

Further, in the distribution unit 47, which information is to be distributed among the above-described information may be set in advance or may be selected by the target pedestrian.

Further, in the distribution unit 47, the communication method of distributing the above-described information to a specific terminal is not particularly limited and may be any known radio communication method or wire communication method.

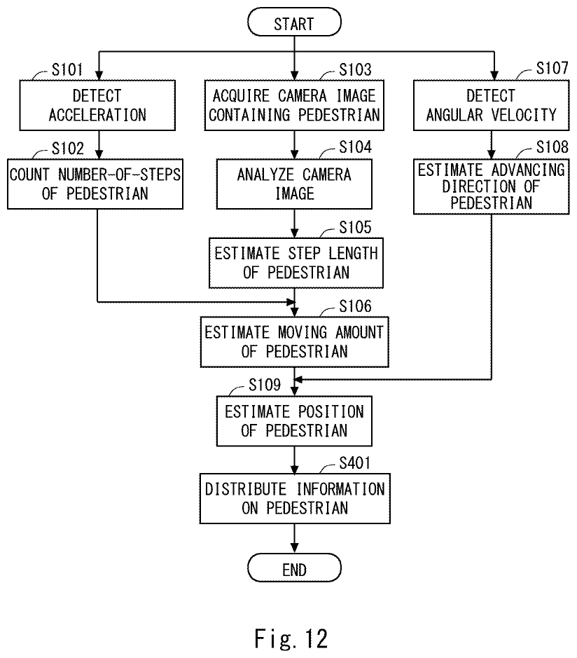

Next, an example of an overall flow of processing performed by the walking estimation system according to the fourth embodiment shown in FIG. 10 will be described with reference to FIG. 12. Here, it is assumed that the target pedestrian is within the angle of view of the camera 10.

As shown in FIG. 12, the overall processing of the walking estimation system according to the fourth embodiment differs from that shown in FIG. 5 of the walking estimation system according to the above-described first embodiment in that Step 5401 is added.

First, the processing of Steps 5101 to 5109 is performed like in the processing shown FIG. 5 of the above-described first embodiment.

Next, the distribution unit 47 distributes at least one of the following information to a specific terminal associated with the ID of the target pedestrian (Step S401):

information on the step length of target pedestrian estimated by the step length estimation unit 43;
information on the moving amount of the target pedestrian estimated by the moving amount estimation unit 44;
information on the advancing direction of the target pedestrian estimated by the advancing direction estimation unit 45; and
information on the position of the target pedestrian estimated by the position estimation unit 46.

As described above, in the walking estimation system according to the fourth embodiment, the distribution unit 47 distributes information such as the information on the estimated step length of the target pedestrian to the specific terminal associated with the ID of the target pedestrian.

By this configuration, it is possible for the target pedestrian and those around the target pedestrian to know the step length of the target pedestrian or the like. Other effects achieved by this configuration are the same as those achieved in the above-described first embodiment.

Note that in the fourth embodiment, the distribution unit 47 was added to the configuration of the above-described first embodiment, but it is not limited to such a configuration. The configuration of the walking estimation system according to the fourth embodiment may be obtained by adding the distribution unit 47 to the configuration of the walking estimation system according to the above-described second embodiment or the configuration of the walking estimation system according to the above-described third embodiment.

### Concept of Embodiments

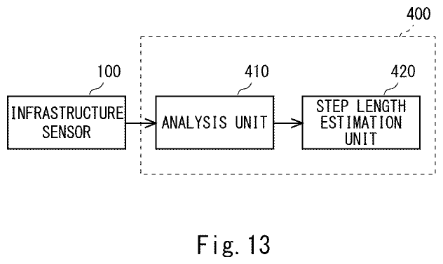

Next, an example of a configuration of a walking estimation system indicating the concept of the walking estimation system according to the above-described first to fourth embodiments will be described with reference to FIG. 13.

The walking estimation system shown in FIG. 13 includes an infrastructure sensor 100 and a walking estimation apparatus 400. Further, the walking estimation apparatus 400 includes an analysis unit 410 and a step length estimation unit 420.

The infrastructure sensor 100 corresponds to any one of the camera 10 shown in FIG. 1 or FIG. 10, the LiDAR 11 shown in FIG. 6, or the millimeter wave radar 12 shown in FIG. 8. The infrastructure sensor 100 acquires an image. For instance, a camera image is acquired when the infrastructure 100 is the camera 10, and a sensing image is acquired when the infrastructure 100 is the LiDAR 11 or the millimeter wave radar 12.

The analysis unit 410 corresponds to the analysis unit 42 shown in FIGS. 1, 6, 8, and 10. The analysis unit 410 analyzes the image acquired by the infrastructure 100, which is an image containing the target pedestrian. To be more specific, the analysis unit 410 detects the positon or the walking speed of the target pedestrian by analyzing the image containing the target pedestrian.

The step length estimation unit 420 corresponds to the step length estimation unit 43 shown in FIGS. 1, 6, 8, and 10. The step length estimation unit 420 estimates the step length of the target pedestrian based on the result of analysis of the image containing the target pedestrian performed by the analysis unit 410. To be more specific, the step length estimation unit 420 estimates the step length of the target pedestrian based on the position or the walking speed of the target pedestrian detected from the analysis of the image performed by the analysis unit 410. Note the detailed configuration of the step length estimation 420 may be, for instance, the configuration shown in FIG. 3. Further, the concrete method of estimating the step length of the target pedestrian performed by the step length estimation unit 420 may be, for instance, the method shown in FIG. 4.

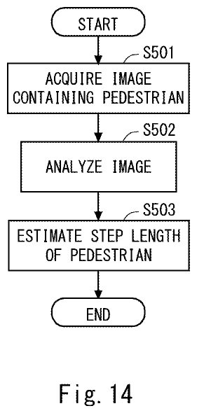

Next, an example of an overall flow of processing performed by the walking estimation system shown in FIG. 13 will be described with reference to FIG. 14. Here, it is assumed that the target pedestrian is within the range that can be sensed by the infrastructure sensor 100 (in the case where the infrastructure sensor 100 is a camera, the angle of view of the camera).

As shown in FIG. 14, the infrastructure sensor 100 acquired the image containing the target pedestrian (Step S501). Next, the analysis unit 410 analyzes the image containing the target pedestrian which is the image acquired by the infrastructure 100 (Step S502). Then, the step length estimation unit 420 estimate the step length of the target pedestrian based on the result of the analysis of the image containing the target pedestrian performed by the analysis unit 410 (Step

S503). To be more specific, the analysis unit 410 detects the position or the walking speed of the target pedestrian by performing analysis of the image containing the target pedestrian, and the step length estimation unit 420 estimates the step length of the target pedestrian based on the position or the walking speed of the target pedestrian detected from the analysis of the image performed by the analysis unit 410.

As described above, in the walking estimation system shown in FIG. 13, the analysis unit 410 analyzes the image acquired by the infrastructure sensor 100, which is an image containing the target pedestrian. Then, the step length estimation unit 420 estimates the step length of the target pedestrian based on the result of analysis on the image performed by the analysis unit 410.

By this configuration, it is possible to suppress degradation in the accuracy of the estimation of the step length of the target pedestrian due to the difference in the situation of the target pedestrian such as the way the target pedestrian walks.

Here, a distribution unit corresponding to the distribution unit 47 shown in FIG. 10 may be added inside the walking estimation apparatus 40 in the walking estimation system shown in FIG. 13. The distribution unit may be configured so as to distribute the information on the step length of the target pedestrian estimated by the step length estimation unit 420 to the specific terminal associates with the target pedestrian.

Note the present disclosure is not limited to the above-described embodiments, and various modifications can be made without departing from the spirit and scope of the present disclosure.

For instance, according to the present disclosure, the walking estimation apparatus is as a computer including a processor such as CPU (Central Processing Unit), a memory, and the like, and the processor may read and execute a computer program stored in the memory to thereby implement the arbitrary processing of the walking estimation apparatus.

In the example described above, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A walking estimation system comprising:
an infrastructure sensor configured to acquire an image;
an analysis unit configured to analyze the image acquired by the infrastructure sensor, the image being an image containing a target pedestrian; and
a step length estimation unit configured to estimate a step length of the target pedestrian based on a result of the analysis of the image containing the target pedestrian performed by the analysis unit.

2. The walking estimation system according to claim 1, wherein
the analysis unit is configured to detect a position or a walking speed of the target pedestrian by analyzing the image containing the target pedestrian, and
the step length estimation unit is configured to estimate the step length of the target pedestrian based on the position or the walking speed of the target pedestrian detected by the analysis unit.

3. The walking estimation system according to claim 1, further comprising:
an acceleration sensor and a gyro sensor built-in in a terminal carried by the target pedestrian;
a number-of-steps counting unit configured to count a number of steps of the target pedestrian based on an acceleration detected by the acceleration sensor;
a moving amount estimation unit configured to estimate a moving amount of the target pedestrian based on the number of steps of the target pedestrian counted by the number-of-steps counting unit and the step length of the target pedestrian estimated by the step length estimation unit;
an advancing direction estimation unit configured to estimate an advancing direction of the target pedestrian based on an angular velocity detected by the gyro sensor; and
a position estimation unit configured to estimate a position of the target pedestrian based on the moving amount of the target pedestrian estimated by the moving amount estimation unit and the advancing direction of the target pedestrian estimated by advancing direction estimation unit.

4. The walking estimation system according to claim 1, further comprising a distribution unit configured to distribute information on the step length of the target pedestrian estimated by the step length estimation unit to a specific terminal associated with identification information of the target pedestrian.

5. A walking estimation method performed by a walking estimation system comprising:
acquiring an image by an infrastructure sensor;
analyzing the image acquired by the infrastructure sensor, the image being an image containing a target pedestrian; and
estimating a step length of the target pedestrian based on a result of the analysis of the image containing the target pedestrian.

6. A non-transitory computer readable-medium storing a program for causing a computer to execute the processes of:
analyzing an image acquired by an infrastructure sensor, the image being an image containing a target pedestrian; and
estimating a step length of the target pedestrian based on a result of the analysis of the image containing the target pedestrian.
